(19) United States
(12) Patent Application Publication
(10) Pub. No.: US 2009/0290099 A1
(43) Pub. Date: Nov. 26, 2009

(54) Display Module

(75) Inventors: Chun-Liang Lin, Hsinchu (TW); Chun-Chieh Wang, Hsinchu (TW); Ya-Ling Hsu, Hsinchu (TW); Chen-Hsien Liao, Hsinchu (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: AU OPTRONICS CORP., Hsinchu (TW)

(21) Appl. No.: 12/235,921

(22) Filed: Sep. 23, 2008

(30) Foreign Application Priority Data
May 26, 2008 (TW) 97119377

(51) Int. Cl. G02F 1/13357

(52) U.S. Cl. 349/70; 349/61

(57) ABSTRACT

A display module is disclosed. The display module comprises a liquid crystal module and a backlight source having a spectrum, wherein the spectrum has a plurality of peaks of light intensity. The liquid crystal module comprises a color filter having a plurality of transmittances. There are color ratios related to the transmittances and the peaks, so that a backlight source emits a light through the color filter and a color image generated by the light has a predetermined brightness and a predetermined saturation according to the color ratios. More particularly, the predetermined brightness can be defined by the brightness as the color temperature of the color image maintained at 10000K. The predetermined intensity meets the standard of the National Television Standard Committee (NTSC).

This application claims the benefit of priority based on Taiwan Patent Application No. 097119377, filed on May 26, 2008, the contents of which are incorporated herein by reference in their entirety.

### CROSS-REFERENCES TO RELATED APPLICATIONS

Not applicable.

### BACKGROUND OF THE INVENTION

1. Field of the Invention

This invention relates to a display module, and more particularly, to a display module for displaying a color image having a predetermined color temperature and a predetermined saturation according to a plurality of color ratios.

2. Descriptions of the Related Art

As the advancement of manufacturing technologies grows, liquid crystal displays (LCDs) have advantages such as a light weight, low profile, low power consumption and lack of radiation. With these properties, LCDs have been widely used in various electronic products, such as personal digital assistants (PDAs), notebook computers, digital cameras, digital video cameras, mobile phones, computer screens, LCD televisions and the like. However, LCD panels are incapable of emitting light themselves, so a light source device is needed for the LCD panel to display images.

Colors of the color image displayed by an LCD television with an LCD panel should meet relevant regulations to avoid poor displaying quality. That is, the color image displayed by the LCD television should have a required color saturation level and a correlated color temperature thereof is supposed to be maintained at ten thousand Kelvin (10000K). Here, the color saturation relates to the standard of the National Television Standard Committee (NTSC). If the color saturation does not meet the standard of the NTSC, the color image may become heavily yellow or heavily blue. Additionally, the phrase “color performance of a white picture at a color temperature of 10000K” means that the color performance demonstrated by the blackbody radiation is at 10000K.

Over recent years, light emitting diode (LED) technologies have progressed. Because of the high definition, high brilliance and high color reproducibility thereof, LEDs are particularly suitable for use as light source devices in LCD televisions. Furthermore, to improve the color performance of the color image displayed by LCD televisions, manufacturers utilize a blue LED grain plus red and green phosphors to generate white light to replace the light emitted by a common white light LED.

FIG. 1 is a schematic view illustrating a spectrum of white light emitted by a blue LED grain plus red and green phosphors. In FIG. 1, the horizontal axis represents light wavelength in nanometers (nm), while the vertical axis represents light intensity in an arbitrary unit (a.u.). There are three peak intensity values 11, 13, 15 in the spectrum. The peak intensity values 11, 13, 15 correspond to a blue light wavelength, a green light wavelength and a red light wavelength of the horizontal axis, respectively. In other words, the peak intensity values 11, 13, 15 represent a blue peak value 11 of light intensity emitted by the blue LED grain, a green peak value 13 of light intensity emitted by the green phosphor, and a red peak value 15 of light intensity emitted by the red phosphor, respectively. According to the prior art, the color temperature of the color image displayed by the LCD television may be further adjusted by altering doping percentages of the red and the green phosphors.

Unfortunately, altering doping percentages of the red and the green phosphors has an impact not only on the color temperature of the color image displayed by the LCD television, but also on the color saturation of the color image. A challenge confronted by the prior art is that, although the color temperature of the color image displayed by the LCD television can be maintained at 10000K by adjusting doping percentages of the red and the green phosphors, the color image usually fails to meet the NTSC standard. If doping percentages of the red and the green phosphors were re-adjusted to meet the NTSC standard, the color temperature of the color image would deviate from 10000K. Therefore, the solutions of the prior art cannot maintain a color temperature of 10000K and meet the NTSC standard at the same time. In view of this, it is highly desirable in the art to design a display module that can achieve both a color temperature of 10000K and meet the NTSC standard at the same time.

### SUMMARY OF THE INVENTION

One objective of this invention is to provide a display module that is able to display a color image having a predetermined color temperature and a predetermined saturation.

In order to achieve above objective, the display module comprises a liquid crystal module and a backlight source. The liquid crystal module has a color filter having a plurality of transmittances. The backlight source has a spectrum which has a plurality of peak values of light intensity. There are color ratios of the transmittances to the peak values. The backlight source emits a light transmitting through the color filter, and a color image generated by the light has a predetermined brightness and a predetermined saturation according to the color ratios. With this arrangement, a color temperature can be maintained at 10000K, and a predetermined saturation can meet the NTSC standard at the same time.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view illustrating a spectrum of the prior art;

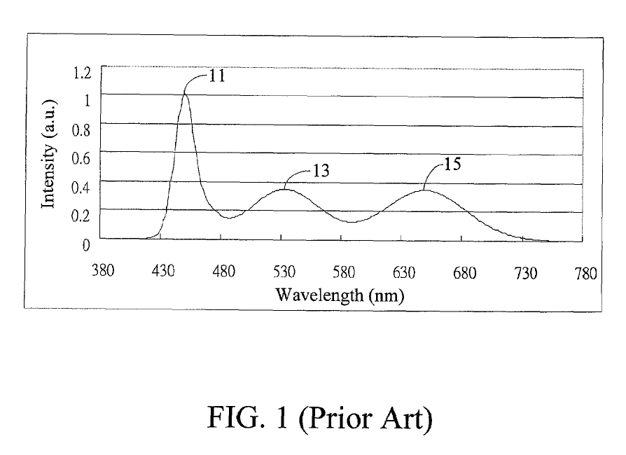

FIG. 2A is a side view illustrating a liquid crystal module according to a first embodiment of the present invention;

FIG. 2B is a top view illustrating a color filter of the liquid crystal module according to the present invention;

FIG. 3 is a side view illustrating a liquid crystal module according to a second embodiment of the present invention; and

FIG. 4 is a side view illustrating a liquid crystal module according to a third embodiment of the present invention.

### DESCRIPTION OF THE PREFERRED EMBODIMENT

One objective of this invention is to provide a display module that is able to display color images having a predetermined color temperature and a predetermined saturation.

However, the following embodiments are only intended to illustrate the concepts of this invention, and this invention is not limited to any specific environment, applications or particular implementations described in these embodiments. It should be appreciated that in the following embodiments and the attached drawings, elements not related directly to this invention are omitted from depiction, and the dimensional relationships among the elements in the attached drawings are only for ease of understanding instead of representing the actual dimensional scales.

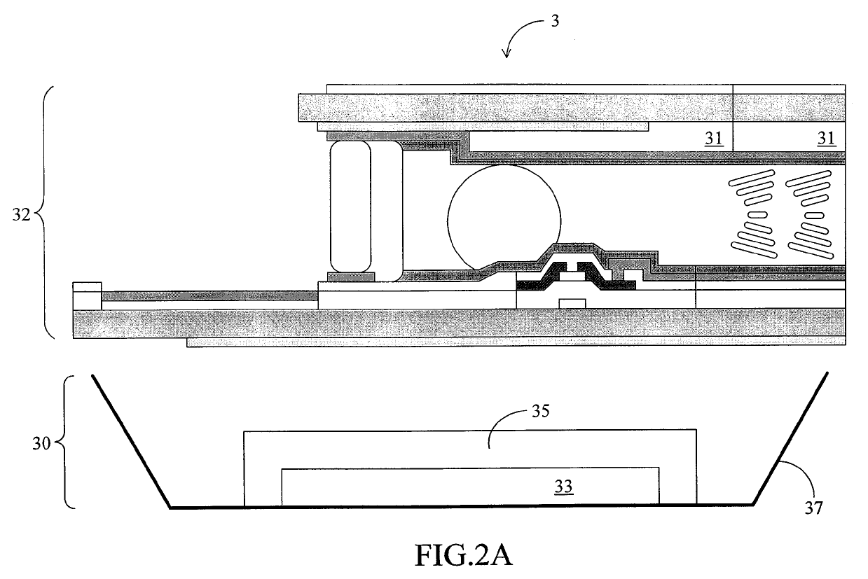

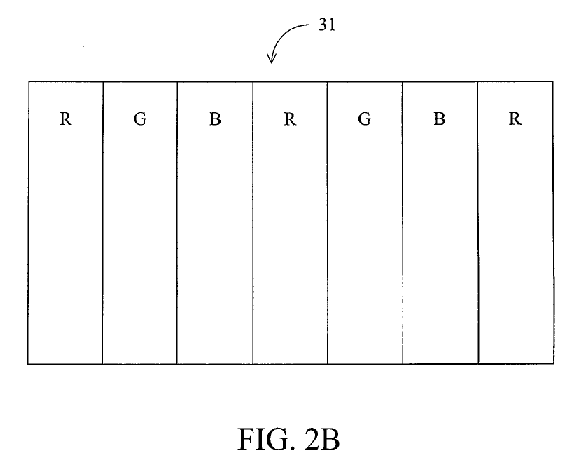

As shown in FIGS. 2A and 2B, a first embodiment of this invention is directed to a liquid crystal display module. FIG. 2A is a side view illustrating the liquid crystal display module. The liquid crystal display module 3 comprises a backlight source 30 and a liquid crystal module 32. The liquid crystal module 32 has a color filter 31. The backlight source 30 comprises a blue LED grain 33, a red phosphor, and a green phosphor, all of which are accommodated together into a reflection cup 37. In this embodiment, the red and the green phosphors are mixed as a red-green phosphor mixture 35 and coated onto a surface of the blue LED grain 33. The blue LED grain 33 and the red-green phosphor mixture 35 provide the backlight source 30 with a spectrum having a plurality of peak values of light intensity.

Specifically, in this spectrum, the blue light emitted by the blue LED grain 33 of the backlight source 30 has a blue peak value of light intensity, which corresponds to a wavelength range from 440 nm to 465 nm in the spectrum; the red light emitted by the red phosphor of the backlight source 30 has a red peak value of light intensity, which corresponds to a wavelength range from 615 nm to 700 nm in the spectrum; and the green light emitted by the green phosphor of the backlight source 30 has a green peak value of light intensity, which corresponds to a wavelength range from 500 nm to 530 nm in the spectrum.

There is a first peak ratio of the green peak value to the blue peak value, and a second peak ratio of the red peak value to the blue peak value. More specifically, the first peak ratio is a specific value of the green peak value to the blue peak value, and the second peak ratio is a specific value of the red peak value to the blue peak value. Each of the peak values is related to brightness of the blue LED grain 33, a concentration and/or a thickness of the red phosphor, and a concentration and/or a thickness of the green phosphor. The relationship between the first peak ratio and the second peak ratio will be detailed hereinafter.

FIG. 2B is a top view illustrating the color filter 31 of the liquid crystal display module 3. The color filter 31 comprises a red pixel region R, a green pixel region G, and a blue pixel region B. The manners of coating the pixel regions R, G, B are well-known to those of ordinary skill in the art, and may vary according to different market demands. There is a plurality of transmittances in the color filter 31 in response to the arrangement of the pixel regions R, G, B.

Specifically, the transmittances comprise a red pixel transmittance, a blue pixel transmittance, and a green pixel transmittance, each of which is related to area ratios among the red pixel region R, the blue pixel region B and the green pixel region G. It should be appreciated that, except for the relations of the area ratios among the red pixel region R, the blue pixel region B and the green pixel region G, the transmittances may also be adjusted by altering a membrane thickness of a dielectric material of the color filter 31, a color concentration of the color filter 31, or the combination thereof. This process is well-known to those of ordinary skill in the art and thus will not be further described herein. There is a first transmittance ratio of the green pixel transmittance to the blue pixel transmittance and a second transmittance ratio of the red pixel transmittance to the blue pixel transmittance. More specifically, the first transmittance ratio is a specific value of the green pixel transmittance to the blue pixel transmittance, and the second transmittance ratio is a specific value of the red pixel transmittance to the blue pixel transmittance.

There are color ratios of the transmittances to the peak values. A color image generated by the light emitted from the backlight source 30 and transmitted through the color filter 31 has a predetermined brightness and a predetermined saturation according to the color ratios. Here, the predetermined brightness means that a color temperature of the color image is maintained at 10000K, and the predetermined saturation meets the NTSC standard.

In more detail, these color ratios comprise a first color ratio and a second color ratio. The first color ratio is the product of the first transmittance ratio and the first peak ratio, and the second color ratio is the product of the second transmittance ratio and the second peak ratio. In this embodiment, each transmittance ratio of the color filter 31 may be first set to a fixed value before the peak ratios of the backlight source 30 are adjusted.

More specifically, the first transmittance ratio (i.e., the transmittance ratio of the green pixel transmittance to the blue pixel transmittance) initially is defined to be 7.92, and the second transmittance ratio (i.e., the transmittance ratio of the red pixel transmittance to the blue pixel transmittance) is defined to be 2.67. Next, the first peak ratio of the backlight source 30 is adjusted to range from 0.25 to 0.31, and the second peak ratio of the backlight source 30 is adjusted to range from 0.26 to 0.36.

As a result, the first color ratio may range from 1.9 to 2.5, and the second color ratio may range from 0.69 to 0.97. It should be noted that, in other examples, the backlight source 30 may comprise a blue LED, a red LED and a green LED, in which case the backlight source 30 also has a spectrum, and the spectrum also has a plurality of peak values of light intensity. Upon reviewing the above description, those of ordinary skill in the art may readily adjust these peak values to meet with the limitations on the ranges of the first and the second peak ratios. Elements included in the backlight source 30 and the method of adjusting the peak ratios will not be further described herein.

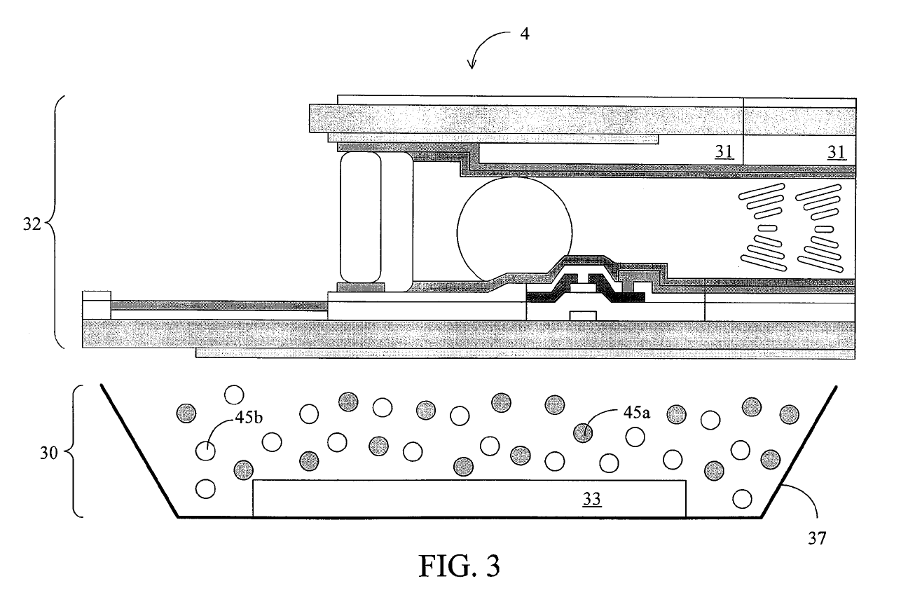

FIG. 3 is a side view illustrating another liquid crystal display module 4 according to a second embodiment of this invention. The liquid crystal display module 4 comprises a liquid crystal module 32 and a backlight source 30. The liquid crystal module 32 has a color filter 31. The backlight source 30 comprises a blue LED grain 33, a red phosphor 45a (denoted by hatched circles), and a green phosphor 45b (denoted by hollow circles), all of which are accommodated together into a reflection cup 37. In the second embodiment, the red phosphor 45a and the green phosphor 45b are sprayed into the reflection cup 37 to fill up the reflection cup 37 to accomplish the same function as the light source device 3 of the first embodiment. Other elements of FIG. 3 having the same reference numerals as those of FIG. 2A have been described in detail in the first embodiment and thus, will not be described again herein.

Similarly, the backlight source 30 has a spectrum which comprises a red peak value, a green peak value, and a blue peak value. The color filter 31 has a red pixel transmittance, a green pixel transmittance, and a blue pixel transmittance. Each of the peak values is related to brightness of the blue LED grain 33, a concentration of the red phosphor and a concentration of the green phosphor. Also, there are color ratios of the transmittances to the peak values. The color image generated by light emitted from the backlight source 30 and transmitted through the color filter 31 has a color temperature maintained at 10000K and a saturation meeting the NTSC standard. The relationships among the aforesaid ratios have been described in detail in the first embodiment and thus, will not be further described again herein.

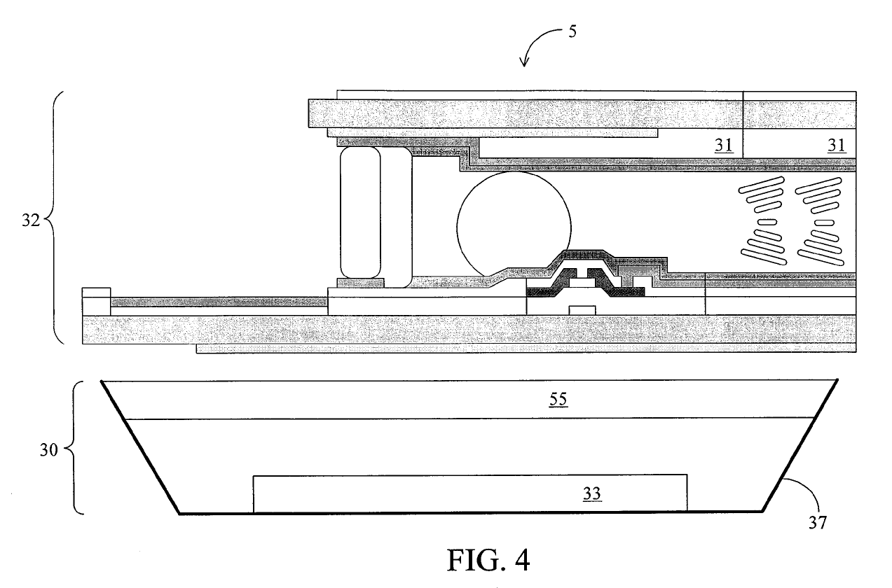

FIG. 4 is a side view illustrating the other liquid crystal display module 5 according to a third embodiment of the present invention. The liquid crystal display module 5 comprises a liquid crystal module 32 and a backlight source 30. The liquid crystal module 32 has a color filter 31. The backlight source 30 comprises a blue LED grain 33, a red phosphor, and a green phosphor, all of which are accommodated together into a reflection cup 37. In the third embodiment, the red phosphor, and the green phosphor are mixed into a red-green phosphor mixture 55 and coated onto a surface of the reflection cup 37 to accomplish the same function as the light source device 3 of the first embodiment. Other elements of FIG. 4 having the same reference numerals as those of FIG. 2A have been described in detail in the first embodiment and thus, will not be described again herein.

As in the first embodiment, the backlight source 30 has a spectrum which includes a red peak value, a green peak value, and a blue peak value. The color filter 31 has a red pixel transmittance, a green pixel transmittance, and a blue pixel transmittance. Each of the peak values is related to a brightness of the blue LED, a concentration and/or thickness of the red phosphor and a concentration and/or thickness of the green phosphor. There are color ratios of the transmittances to the peak values. The color image generated by the light emitted from the backlight source 30 and transmitted through the color filter 31 has a color temperature maintained at 10000K and a saturation meeting the NTSC standard. The relationships among the aforesaid ratios have been described in detail in the first embodiment and thus, will not be further described again herein.

In each of the liquid crystal display modules 3, 4, 5, by adjusting the backlight source 30 and the color filter 31 simultaneously, the color image generated by the light emitted from the backlight source 30 and transmitted through the color filter 31 have a color temperature maintained at 10000K and a saturation level of above 0.9 that meets to the NTSC standard. Accordingly, the brightness and color saturation requirements of the color image can be both confirmed. The values of the aforesaid ratios are only provided for purpose of illustration, and those of ordinary skill in the art may use other ratio values in alternative designs while still achieving a color temperature maintained at 10000K and a saturation that meets the standard of the NTSC for color images displayed.

The above disclosure is related to the detailed technical contents and inventive features thereof. People having ordinary skills in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A display module, comprising:
a liquid crystal module having a color filter, wherein the color filter has a plurality of transmittances; and
a backlight source having a spectrum, wherein the spectrum has a plurality of peak values of light intensity;
wherein there exists a plurality of color ratios of the transmittances to the peak values, the backlight source emits a light through the color filter, and a color image generated by the light has a predetermined brightness and a predetermined saturation according to the color ratios.

2. The display module of claim 1, wherein the transmittances include a red pixel transmittance, a blue pixel transmittance, and a green pixel transmittance, the green pixel transmittance to the blue pixel transmittance determines a first transmittance ratio, and the red pixel transmittance to the blue pixel transmittance determines a second transmittance ratio.

3. The display module of claim 2, wherein the first transmittance ratio is a specific value of the green pixel transmittance and the blue pixel transmittance; and the second transmittance ratio is a specific value of the red pixel transmittance and the blue pixel transmittance.

4. The display module of claim 3, wherein the peak values include a red peak value, a green peak value and a blue peak value, the green peak value to the blue peak value determines a first peak ratio, and the red peak value to the blue peak value determines a second peak ratio.

5. The display module of claim 4, wherein in the spectrum, the red peak value is located from 615 nanometer (nm) to 700 nm of a wavelength, the green peak value is located from 500 nm to 530 nm of the wavelength, and the blue peak value is located from 440 nm to 465 nm of the wavelength.

6. The display module of claim 4, wherein the first peak ratio is a specific value of the green peak value and the blue peak value, and the second peak ratio is a specific value of the red peak value and the blue peak value.

7. The display module of claim 6, wherein the value of the first peak ratio ranges from 0.25 to 0.31, and the value of the second peak ratio ranges from 0.26 to 0.36.

8. The display module of claim 6, wherein the color ratios include a first color ratio and a second color ratio, the first color ratio is the product of the first transmittance ratio and the first peak ratio, and the second color ratio is the product of the second transmittance ratio and the second peak ratio.

9. The display module of claim 8, wherein the value of the first color ratio ranges from 1.9 to 2.5, and the value of the second color ratio ranges from 0.69 to 0.97.

10. The display module of the claim 1, wherein each of the transmittances is related to one of color concentration of the color filter, a membrane thickness of a dielectric material, and the combination thereof.

11. The display module of claim 2, wherein the color filter comprises a red pixel region, a green pixel region, and a blue pixel region, and the red transmittance, the green transmittance, and the blue transmittance are related to an area ratio among the red pixel region, the green pixel region and the blue pixel region.

12. The display module of claim 1, wherein the backlight source includes a blue light emitting diode (LED) grain, a red phosphor, and a green phosphor, and each of the peak values is related to brightness of the blue LED grain, concentration of the red phosphor and the green phosphor.

13. The display module of claim 1, wherein the backlight source includes a blue light emitting diode (LED) grain, a red phosphor and a green phosphor, each of the peak values is related to brightness of the blue LED grain, thickness of the red phosphor and the green phosphor.

14. The display module of claim 1, wherein the predetermined brightness indicates that the color temperature of the color image is maintained at ten thousand Kelvin (10000K).

15. The display module of claim 1, wherein the predetermined saturation meets the standard of National Television Standard Committee (NTSC).
